(19) United States
(12) Patent Application Publication
(10) Pub. No.: US 2007/0278959 A1
(43) Pub. Date: Dec. 6, 2007

(54) SELF BALLASTED COMPACT FLUORESCENT LAMP AND LIGHTING APPARATUS

(75) Inventors: Kunihiko Ikada, Kanagawa-Ken (JP); Takeo Yasuda, Kanagawa-Ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOSHIBA LIGHTING & TECHNOLOGY CORPORATION, Shinagawa-Ku (JP)

(21) Appl. No.: 11/755,532

(22) Filed: May 30, 2007

(30) Foreign Application Priority Data
May 31, 2006 (JP) 2006-152671

(51) Int. Cl. H01J 61/30

(52) U.S. Cl. 313/634

(57) ABSTRACT

A self ballasted compact fluorescent lamp is provided with a cover, a globe having a small-diameter portion formed on a side of an open end portion which is attached to the fitting end portion of the cover, and an arc tube accommodated in the globe and provided with a bulb having a pair of electrodes. The bulb includes a spiral portion connected to the electrodes, the spiral portion having a helix diameter larger than the small-diameter portion of the globe at least a portion of the spiral portion, and the spiral portion further includes a short discharge path portion which is continuously and integrally formed with the spiral portion, has a pair of electrode sealed end portions on the side of the small-diameter portion of the globe and has a discharge path length shorter than the spiral portion. A lighting control circuit unit is accommodated and connected to the base in the cover. A lighting apparatus includes such compact fluorescent lamp and an apparatus body to which the lamp is attached.

### BACKGROUND OF THE INVENTION

1. Field of The Invention

The present invention relates to a self ballasted compact fluorescent lamp (which may be called hereinafter merely as compact fluorescent lamp (CFL)) and also relates to a lighting apparatus provided with the self ballasted compact fluorescent lamp.

2. Related Art

In the known art, a self ballasted compact fluorescent lamp of this type has such a compact size that its dimensions are almost the same as those of a general light bulb that is defined in JIS (Japanese Industrial Standard), and has an outer appearance approximate to that of the general light bulb.

A compact fluorescent lamp of this type is provided with an arc tube having a curved bulb, a cover including a base fitted to one end of a cover body of the cover while supporting the arc tube at the other end of the cover body, a lighting device accommodated in the cover, and a globe fitted to the other end of the cover so as to cover the arc tube (see, for example, in Japanese Unexamined Patent Application Publication No. 2000-21351).

In recent years, there has been proposed a curved bulb that is arranged in a small space within a globe and is formed into a spiral shape to attempt to increase the length of a discharge path (see, for example, in Japanese Unexamined Patent Application Publication No. 2003-263972 and Japanese Unexamined Patent Application Publication No. 2003-31179).

However, in such an existing spiral compact fluorescent lamp, the spiral end portions of a spiral arc tube extend within the cover and the end portions of the arc tube are supported by a holder arranged in the cover, providing a disadvantage such that the size of the cover becomes large.

In addition, the cover is a portion through which light is not generally emitted outside because light emitted from the arc tube is not allowed to penetrate through the cover. If the width of the holder is large, light irradiated toward the holder is not sufficiently reflected, resulting in an increase in the percentage of loss. Thus, the luminous efficacy tends to be reduced.

Furthermore, a method of forming a bulb into a spiral shape is illustrated, for example, in FIGS. 6 and 7 of Japanese Unexamined Patent Application Publication No. 2003-31179. When a complex die having multiple radial segments around which a bulb is wound and which is movable in the radial direction is used, it is not easy to manufacture a spiral arc tube and, in addition, its yield percentage decreases.

Then, the globe accommodating such spiral bulb includes a spherical top end portion side having a maximum-diameter portion and a cylindrical small-diameter portion having a diameter smaller than the maximum-diameter portion, these maximum-diameter portion and the small-diameter portion being continuously and integrally formed. Even in this narrow small-diameter portion, when a bulb is formed into a spiral shape, an overall helix diameter needs to be reduced to conform with the small-diameter portion. As the helix diameter becomes smaller, the bulb diameter needs to be reduced to ensure a predetermined discharge path length. However, the bulb diameter excessively decreases, the luminous efficacy is deteriorated, and as a result, the discharge starting voltage and lamp lighting voltage increase, thus being disadvantageous.

Moreover, when the bulb diameter becomes further small, it is not easy to mold a straight tube type glass bulb into a spiral shape using a die and, in addition, cracking or distortion is more likely to occur upon molding. This causes such a drawback that the yield percentage is decreased when spiral glass bulbs are mass-produced.

### SUMMARY OF THE INVENTION

The present invention was conceived in consideration of the circumstances mentioned above and an object thereof is to provide a self ballasted compact fluorescent lamp and a lighting apparatus that can improve luminous efficacy

The above and other objects can be achieved according to one aspect of the present invention by providing a self ballasted compact fluorescent lamp comprising:

a cover including a cover body having one end to which a base is connected and another end to which a fitting end portion is formed;

a globe having a small-diameter portion formed on a side of an open end portion which is attached to the fitting end portion of the cover, small-diameter portion being smaller in diameter than a maximum-diameter portion located on a top end side of the globe opposite to the open end portion thereof;

an arc tube accommodated in the globe and provided with a bulb having a pair of electrodes, the bulb including a spiral portion connected to the electrodes, the spiral portion being located on the maximum-diameter portions side in the globe and having a helix diameter larger than the small-diameter portion of the globe at least a portion of the spiral portion, and the spiral portion further including a short discharge path portion which is continuously and integrally formed with the spiral portion, has a pair of electrode sealed end portions on the side of the small-diameter portion of the globe and has a discharge path length shorter than the spiral portion; and

a lighting control circuit unit accommodated and connected to the base in the cover.

According to this aspect, the spiral portion of the arc tube is accommodated in a portion on the side of (adjacent to) the top end portion, having a relatively large internal volume, including the maximum-diameter portion of the globe, and accordingly, the helical diameter is increased to make it possible to ensure the discharge path length. For this reason, it is not necessary to excessively reduce the bulb diameter substantially over the overall length of the arc tube including the short discharge path portion and spiral portion of the arc tube. This makes it possible to improve luminous efficacy and also possible to avoid an increase in starting voltage. In another aspect of the present invention, there is also provided a compact fluorescent lamp comprising:

A compact fluorescent lamp comprising:

a cover including a cover body having one end to which a base is connected and another end to which a fitting end portion is formed;

a globe having a small-diameter portion formed on a side of an open end portion which is attached to the fitting end portion of the cover, small-diameter portion being smaller in diameter than a maximum-diameter portion located on a top end side of the globe opposite to the open end portion thereof;

an arc tube accommodated in the globe and provided with a spiral bulb having a pair of electrodes, the spiral bulb including a spiral portion connected to the electrodes, and the spiral bulb having a dense pitch portion and a sparse pitch portion, wherein the dense pitch portion is positioned on the side of the top end portion including the maximum-diameter portion of the globe and has a dense pitch of helical winding, at least partially having a helix diameter larger than the small-diameter portion of the globe, and the sparse pitch portion is continuously and integrally formed with the dense pitch portion and has a pair of electrode sealed end portions, the sparse pitch portion being positioned on the side of the small-diameter portion of the globe and has a sparse pitch of helical winding; and

a lighting control circuit unit accommodated and connected to the base in the cover.

According to this aspect, the dense pitch portion of the spiral arc tube is accommodated in a portion on the side of (adjacent to) the top end portion, having a relatively large internal volume, including the maximum-diameter portion of the globe, and accordingly, the helix diameter both may be increased.

In addition, because the sparse portion of the arc tube is accommodated in a portion on the side of the narrow small-diameter portion of the globe and the pitch of helical winding is also sparse, it does not have a longer discharge path length than the dense pitch portion. Then, the discharge path length required for the arc tube is mostly assigned to the dense pitch portion, so that it is possible to make the sparse pitch portion have the same thick bulb diameter as the dense pitch portion.

For this reason, the surface area per unit length of a fluorescent material film formed on the inner surface of the bulb may be increased, thus making it possible to improve light flux and luminous efficacy.

Furthermore, since the bulb diameter and the helix diameter both may be increased, a molding process may be made easy at a time when a glass bulb is formed into a spiral shape by molding with a die.

In a further aspect of the present invention, there is also provided a compact fluorescent lamp comprising:

a cover including a cover body having one end to which a base is connected and another end to which a fitting end portion is formed;

a globe having a small-diameter portion formed on a side of an open end portion which is attached to the fitting end portion of the cover, small-diameter portion being smaller in diameter than a maximum-diameter portion located on a top end side of the globe opposite to the open end portion thereof;

an arc tube accommodated in the globe and provided with a bulb having a pair of electrodes, the bulb including a spiral portion connected to the electrodes, the spiral portion being located on the maximum-diameter portions side in the globe and having a helix diameter larger than the small-diameter portion of the globe at least a portion of the spiral portion, and the spiral portion further including a short discharge path portion which is continuously and integrally formed with the spiral portion, the bulb further including a straight portion which is continuously and integrally formed with the spiral portion and arranged on the side of the small-diameter portion of the globe, and has a pair of electrode sealed end portions extending in an axial direction of helix of the spiral portion; and

a lighting control circuit unit accommodated and connected to the base in the cover.

According to this aspect, the spiral portion of the arc tube is accommodated in a portion on the side of (adjacent to) the top end portion, having a relatively large internal volume, including the maximum-diameter portion of the globe, and accordingly, the bulb diameter and the helix diameter both may be increased.

In addition, since the straight portion of the arc tube is accommodated in a portion adjacent to the narrow small-diameter portion of the globe and has a discharge path length shorter than the spiral portion, the discharge path length required for the arc tube is mostly assigned to the spiral portion. Thus, the helical diameter is increased to make it possible to ensure the discharge path length. For this reason, the bulb diameter need not be excessively reduced substantially over the overall length of the arc tube, including the straight portion and spiral portion of the arc tube.

Furthermore, the surface area per unit length of a fluorescent material film formed on the inner surface of the bulb may be increased, thus making it possible to improve light flux and luminous efficacy.

In addition, since the bulb diameter and the helix diameter both may be increased, it is possible to make it easier to form a glass bulb into a spiral shape by molding with a die and, moreover, it is possible to reduce an occurrence of cracking or distortion when it is molded. As a result, both the mass productivity and yield percentage of a bulb having a spiral portion may be improved.

In a still further aspect of the present invention, there is provided a self ballasted compact fluorescent lamp comprising:

a cover including a cover body having one end to which a base is connected and another end to which a fitting end portion is formed;

a globe having a small-diameter portion formed on a side of an open end portion which is attached to the fitting end portion of the cover, small-diameter portion being smaller in diameter than a maximum-diameter portion located on a top end side of the globe opposite to the open end portion thereof;

an arc tube accommodated in the globe and provided with a bulb having a pair of electrodes, the bulb including a spiral portion connected to the electrodes, the spiral portion being located on the maximum-diameter portions side in the globe and having a helix diameter larger than the small-diameter portion of the globe at least a portion of the spiral portion, and the spiral portion further including a short discharge path portion which is continuously and integrally formed with the spiral portion, the bulb further including a bulb end portion bent such that an electrode sealed end portion extends on a base side by being bent at a turning angle within ¾ peripheral length of a spiral shape on the base side from the maximum diameter portion of the spiral portion; and

a lighting control circuit unit accommodated and connected to the base in the cover.

According to the self ballasted compact fluorescent lamp of this aspect, the spiral portion of the arc tube is accommodated in a portion on the side of (adjacent to) the top end portion, having a relatively large internal volume, including the maximum-diameter portion of the globe, and accordingly, the bulb diameter and the helix diameter both may be increased.

In addition, since the straight portion of the arc tube is accommodated in a portion adjacent to the narrow small-diameter portion of the globe and has a discharge path length shorter than the spiral portion, the discharge path length required for the arc tube is mostly assigned to the spiral portion. Thus, the helical diameter is increased to make it possible to ensure the discharge path length. For this reason, the bulb diameter need not be excessively reduced substantially over the overall length of the arc tube, including the straight portion and spiral portion of the arc tube.

Furthermore, the surface area per unit length of a fluorescent material film formed on the inner surface of the bulb may be increased, thus making it possible to improve light flux and luminous efficacy.

In addition, since the bulb diameter and the helix diameter both may be increased, it is possible to make it easier to form a glass bulb into a spiral shape by molding with a die and, moreover, it is possible to reduce an occurrence of cracking or distortion when it is molded. As a result, both the mass productivity and yield percentage of a bulb having a spiral portion may be improved.

Still furthermore, since the bulb end portion of the arc tube is bent so as to extend to the base side by being bent at a turning angle of ¾ peripheral length of the spiral shape to the base side of the maximum-diameter portion, when the bulb end portion is bent, the bulb can be easily bent and formed without using a specific die. For this reason, the bent formation of the bulb end portion from the spiral portion can be easily and smoothly performed with the improved yielding of the arc tube.

In the above aspect, it may be desired that the bulb has an outer diameter of 7 to 10 mm, and the discharge path length is 360 to 610 mm.

According to the above embodiment, since the bulb has an outer diameter of 7 to 9 mm, the number of helical turns of the spiral portion of the arc tube, which is accommodated in the globe having the maximum diameter of 55 to 60 mm, is increased, thus making it possible to increase the discharge path length. For this reason, the luminous efficacy is improved to make it possible to reduce an occurrence of cracking or distortion in the spiral portion.

That is, when the bulb has a small outer diameter of less than 7 mm, discharge starting voltage and lamp lightening voltage may increase, resulting in enlargement of a lighting apparatus, and moreover, when the bulb has an outer diameter less than 7 mm, the helical turns of the spiral portion of the arc tube arranged in a predetermined space in the globe is increased to make it possible to increase the discharge path length. However, because the glass bulb has an excessively small outer diameter, cracking or distortion is likely to occur when the straight circular tube glass bulb is formed into a spiral shape by molding with a die. For this reason, it is disadvantageous in that yield percentage, when a spiral glass bulb is mass-produced, is decreased.

On the other hand, when the bulb has a large outer diameter above 10 mm, because the number of helical turns is reduced and the discharge path length becomes short, the luminous efficacy cannot be improved. Further, when a compact arc tube is desired, the upper limit of the bulb outer diameter may be 9 mm.

In addition, for the purpose of improving the luminous efficacy, the bulb desirably has a discharge path length of 400 mm or above. However, when compactness of the arc tube has a higher priority over improvement of luminous efficacy, the discharge path length may be 360 mm or above. However, when the discharge path length is above 610 mm, the starting voltage also becomes high. This may create a new problem that the small lighting device arranged in the cover becomes large and, as a result, it is difficult to accommodate the lighting device in the cover.

In the above aspects, it may be also desired that the maximum-diameter portion of the globe is to be 2.0 to 2.5 times an outer diameter of the base and the outer diameter of the small-diameter portion of the globe is to be 1.0 to 1.5 times of the outer diameter of the base.

In this case, a desirable outer appearance of the fluorescent lamp can be maintained.

Furthermore, it may be desired that a shortest distance between an inner surface of the globe and an outer surface of an arc tube is 2 to 7 mm.

In this case, the fine outer appearance can be maintained, as well as required lightness can be achieved. In the case of less than 2 mm, the outer surface of the arc tube is seen through the glove, which damages the outer appearance of the lamp, and in addition, the globe will be excessively heated, thus being inconvenient. On the other hand, in the case of more than 7 m, the arc tube is too large to obtain the required lightness.

In a still further aspect, the above object can be achieved by providing a lighting apparatus comprising: the compact fluorescent lamp of the type mentioned above; and an apparatus unit body to which the compact fluorescent lamp is attached.

According to the lighting apparatus mentioned above, since the lighting apparatus is provided with the compact fluorescent lamp as set forth in the preceding one aspects of present invention, the lighting apparatus having the advantages of these compact fluorescent lamps may be attained.

The nature and further characteristic features of the present invention will be made clearer from the following descriptions made with reference to the accompanying drawings.

### BRIEF DESCRIPTION OF THE DRAWINGS

In the accompanying drawings:

FIG. 1 is a front view of a self ballasted compact fluorescent lamp, with a partially elevational section, according to a first embodiment of the present invention;

FIG. 2 is a front view of an arc tube of the compact fluorescent lamp shown in FIG. 1;

FIG. 3 is a plan view of the arc tube shown in FIG. 1; and

FIG. 4 is a plan view of the arc tube shown in FIG. 1 after the formation of a spiral portion;

FIG. 5 is a plan view of the arc tube shown in FIG. 1 after the formation of a straight portion; and

FIG. 6 is a schematic structural view showing a lighting apparatus according to a second embodiment of the present invention.

### DESCRIPTION OF THE PREFERRED EMBODIMENTS

Hereunder, preferred embodiments according to the present invention will be described with reference to the accompanying drawings. Further, it is to be noted that the same reference numerals are assigned to the same or corresponding portions shown in the plurality of accompanying drawings, and also noted that terms “upper”, “lower”, “right”, “left” and the like terms are used herein with reference to the illustrated embodiments.

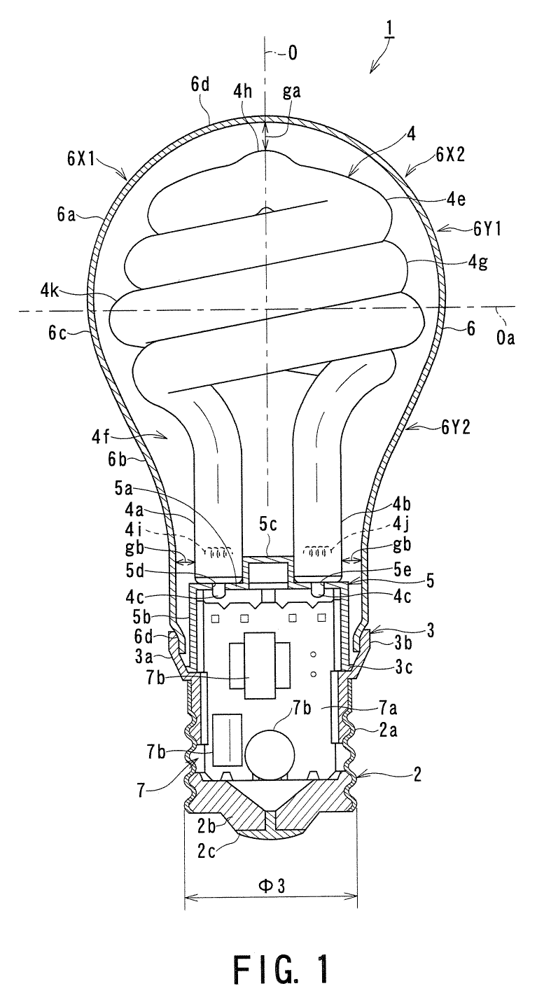

As shown in FIG. 1, a compact fluorescent lamp 1 is provided with a cover 3, an arc tube 4, a holder 5, a globe 6, and a lighting control circuit unit 7. The cover 3 includes a base 2 at one end (i.e., lower end in FIG. 1) in the longitudinal direction thereof (i.e., axial direction of the tube). The arc tube 4 is supported on the side of the other end (i.e., upper end in FIG. 1) of the cover 3. The holder 5 is attached to the cover 3 and supports one end of the arc tube 4. The globe 6 covers the arc tube 4 and is attached to the cover 3 so as to cover the holder 5 at one end. The lighting control circuit unit 7 is accommodated inside the base 2 and the cover 3. Then, the compact fluorescent lamp 1 is formed to have dimensions and an appearance which approximate to those of a general light bulb such as an incandescent light bulb having a rated power of, for example, 40 W, 60 W, or 100 W (JIS C 7501).

The base 2 is an Edison type model E26, or the like, and includes a cylindrical shell 2a having a thread formed thereon, and an eyelet 2c provided on the bottom thereof adjacent to one end of the shell 2a through an electrically insulating portion 2b. The other end of the shell 2a covers one end portion of the cover 3, and the shell 2a is fixed to the cover 3 by means of an adhesive agent or caulking.

The cover 3 includes a cover body 3a, which is, for example, formed of a heat-resistant synthetic resin such as polybutylene-terephthalate (PBT), in which an inverted frustum shaped portion that gradually reduces its diameter in the downward direction in FIG. 1 is formed continuously and integrally with a cylindrical portion. The shell 2a of the base 2 is attached to one end of the cover body 3a (i.e., lower end in FIG. 1), while an annular open fitting end 3b, which serves as a fitting end portion, is formed at the other end (i.e., upper end in FIG. 1) of the cover body 3a.

The cylindrical lower open end of the holder 5 is engaged with the protruded step portion 3c of the cover body 3a, which is located inside the connection between the frustum shaped portion and cylindrical portion of the cover body 3a inside the open fitting end 3b.

That is, the holder 5 is formed of a heat-resistant synthetic resin such as PBT and formed into a cylindrical shape having a closed end at one side forming a disc-shaped base portion 5a. A cylindrical portion 5b is integrally formed so as to extend from the peripheral end of the base portion 5a toward the lower end of the holder 5 (i.e., lower end in FIG. 1). The lower open end in FIG. 1 of the cylindrical portion 5b is fixedly mounted on the projecting step portion 3c of the cover body 3a by means of an adhesive agent, or the like.

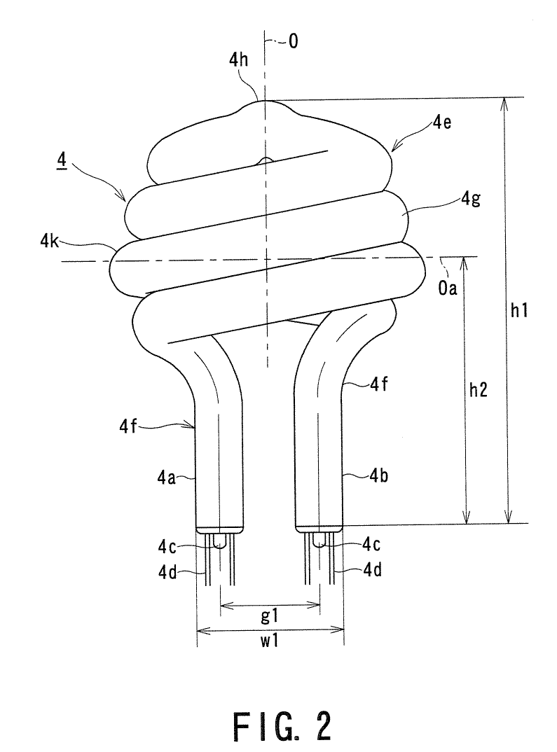

The holder 5 includes support recesses and a cylindrically projecting portion 5c, which are formed on the base portion 5a. A pair of end portions 4a sealing electrodes (electrode sealing end portions) 4a, 4b of the arc tube 4 are mounted and supported by the support recesses. The cylindrically projecting portion 5c projects into a gap formed between these electrode sealing end portions 4a, 4b to restrict their radial displacement. The base portion 5a has through holes 5d, 5e both formed on the outer side of the cylindrically projecting portion 5c. The through holes 5d, 5e are formed so as to pass narrow tubes 4c extending outward from the pair of the electrode sealing end portions 4a, 4b of the arc tube 4, and outer wires 4d shown in FIG. 2.

The globe 6 is formed of a transparent or light diffusion material such as glass or synthetic resin. The globe 6 is formed so as to provide a smooth curved shape that is approximate to the shape of a glass bulb of a general light bulb such as an incandescent light bulb. That is, the globe 6 has a spherical portion 6a, which is substantially spherical, and a substantially cylindrical small-diameter portion 6b, having a diameter gradually reduced to be smaller than the diameter of the spherical portion 6a. The spherical portion 6a is continuously and integrally formed at the lower end thereof as shown in FIG. 1 with the small-diameter portion 6b. The spherical portion 6a includes a maximum-diameter portion 6c at which the globe 6 has a maximum-diameter. The small-diameter portion 6b has an open end portion 6d formed at one end portion (i.e., lower end portion in FIG. 1) of the globe 6. The edge of the open end portion 6d is fitted into the open fitting end 3b of the cover 3 and is then fixed by using, for example, silicon resin or epoxy resin.

The globe 6 is formed so as to have a thickness of, for example, 1.5 mm, and have the maximum-diameter portion 6c of an outer diameter of 55 to 66 mm which is 2.0 to 2.5 times the outer diameter φ 3 (26 mm) of the base 2, the maximum-diameter portion 6c being accorded with the maximum diameter 4k of the arc tube 4. Furthermore, the outer diameter of the small-diameter portion 6b of the globe 6 is formed to be 26 to 39 mm, which is 1.0 to 1.5 times the outer diameter φ 3 of the base 2. Further, the base 2 having the outer diameter of 17 mm may be also utilized.

In addition, the compact fluorescent lamp 1is formed, as shown in FIG. 1, such that a shortest distance connecting the inner surface of the globe 6 and the outer surface of the arc tube 4 is to be 2 to 7 mm. For example, the shortest distance ga in the vertical direction in FIG. 1 between the inner surface of the top end 6d of the globe 6 and the outer diameter of the top end 4h of the arc tube 4 is formed to be 2 mm and the shortest distance gb in the horizontal direction in FIG. 1 between the inner surface of the small-diameter portion 6b of the globe 6 and the outer diameter of the electrode sealing end portions 4a, 4b being the paired straight portions 4f, 4f of the arc tube 4 is formed to be 3 mm.

The globe 6 is longitudinally divided into a left half portion 6X1 and a right half portion 6X2 in FIG. 1 with respect to the central axis of the globe 6 which accords with the central axis O of the arc tube 4.

That is, if the globe 6 is, for example, not divided and formed integrally, the arc tube 4 cannot be inserted into the globe 6 through the open end portion 6d because the maximum outer diameter portion 4k of the arc tube 4 has an outer diameter larger than the open end portion 6d of the globe 6.

However, since the globe 6 is divided into the left half portion 6X1 and the right half portion 6X2 with respect to the central axis O, after the arc tube 4 is mounted at the position on the holder 5, the arc tube 4 is covered with the left half portion 6X1 and right half portion 6X2 of the globe 6 from its side, and the left half portion 6X1 and right half portion 6X2 are connected, thus making it possible to attach them to the cover 3.

Thereafter, the globe 6 is covered with a pouch-like heat-shrinkable film having a desired shape, not shown. By heat-shrinking the heat-shrinkable film, the left half portion 6X1 and right half portion 6X2 of the globe 6 may be integrated together.

It is to be noted that the globe 6 may be divided in a transverse direction (horizontal direction). In this case, as shown by a broken line in FIG. 1, the globe 6 may be divided into two sections 6Y1 and 6Y2 in the longitudinal direction in FIG. 1 by using the central axis Oa of the maximum outer diameter portion 4k of the arc tube 4 as a horizontal dividing line. In this case, the horizontal dividing line is the central axis Oa of the maximum outer diameter portion 4k of the arc tube 4, and the overall arc tube 4 may be hence covered with a pair of upper and lower globe sections 6Y1, 6Y2. Further, the divided portions in the vertical and horizontal directions of the globe may be fixed by means of ultrasonic welding or vibration fixing.

The arc tube 4 includes a spiral portion 4e formed at its upper and intermediate portions in FIG. 1, and straight portions 4f formed at its lower portion. The spiral portion 4e and the straight portions 4f are connected integrally with each other.

The spiral portion 4e is formed by folding a glass bulb 4g of straight cylindrical tube shape having an outer diameter of, for example, 8.5 mm substantially in half, winding the same around a die, not shown, at the middle position thereof, i.e., a turn-back portion 4h, made as the top end, and then molding the same into a double helix shape.

The glass bulb 4g has a fluorescent material film, made of a rare earth, metal oxide or the like, formed on its inner surface. The fluorescent material film is formed substantially over the overall length of the glass bulb 4g. The glass bulb 4g has the electrode sealing end portions 4a, 4b formed at the ends thereof in the axial direction, respectively, so as to seal a pair of electrodes 4i, 4j.

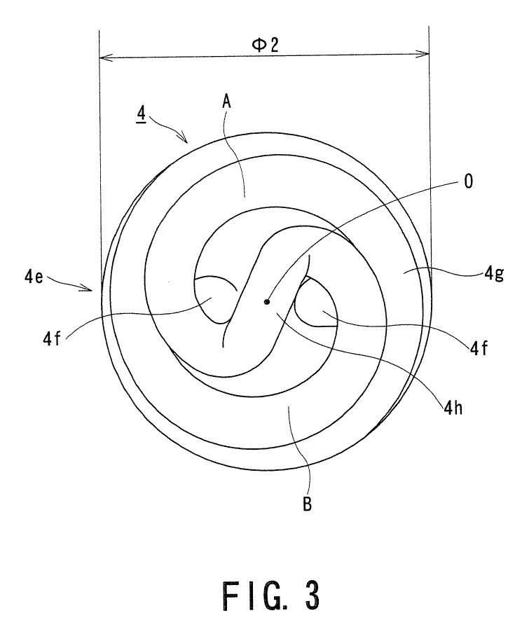

That is, as shown in FIG. 3, the spiral portion 4e has a double helix shape including a first spiral portion “A” extending from one electrode sealing end portion, for example, 4a, of the glass bulb 4g, turning about the turning axis O, to the turn-back portion 4h, which is the top end portion located in the upper part of FIG. 1, and a second spiral portion “B” extending from the other end of the turn-back portion 4h, turning about the turning axis O to the other electrode sealing end portion 4b, of the glass bulb 4g. Each of the respective spiral portions has, for example, substantially two turns (the number of turns). Thus, the spiral portion 4e is formed at a dense pitch portion, which has a dense helical pitch and is formed as a long discharge path portion having a long discharge path length. Further, the turn-back portion 4h, which is the top end portion of the spiral portion 4e, may be formed at a bulged portion having a bulb diameter larger than the first and second spiral portions “A” and “B”, and a cold spot may be formed at the bulged portion.

The pair of electrodes 4i, 4j are formed of, for example, a coil electrode made of tungsten and are, for example, sealed within the ends of the glass bulb 4g and temporarily connected by using bead glass.

A discharge medium, such as argon gas and krypton gas, is encapsulated inside of the glass bulb 4g. The narrow tubes 4c are formed on the outer surfaces of the pair of electrode sealing end portions 4a, 4b so as to communicate with the inside thereof. Mercury or amalgam is accommodated in the narrow tubes 4c.

The spiral portion 4e is accommodated in the spherical portion 6a of the globe 6 adjacent to the open end portion 6d including the maximum-diameter portion 6c. The spiral portion 4e gradually increases its helix diameter from the turn-back portion 4h of the top end toward the maximum-diameter portion 6c in correspondence with the inner surface shape of the spherical portion 6a of the globe 6, having a maximum helix diameter at the maximum-diameter portion 6c of the globe 6, and then gradually reduces its helix diameter in correspondence with the reduction in diameter of the lower half portion of the spherical portion 6a of the globe 6. The spiral portion 4e is continuously and integrally formed with the upper end portions (in FIG. 1) of the straight portions 4f.

As shown in FIG. 1, the straight portions 4f are bent at a pair of spiral terminal portions of the spiral portion 4e in the lower portion of the glass bulb 4g so as to extend substantially at a right angle downward in the axial direction of the cylindrically shaped portion 6b of the globe 6. The pair of straight electrode sealing end portions 4a, 4b are arranged substantially in parallel with each other and are inserted into the support recesses of the holder 5. Each of the straight portions 4f has a discharge path length shorter than the spiral portion 4e so as to be formed as a short discharge path portion.

Further, the straight portions 4f may be formed into a spiral shape by slightly curving the glass bulb 4g so as to coincide with the turning direction of the spiral portion 4e. However, in this case, the die for forming the spiral portion 4e is withdrawn, the bending working may be done manually or turned by using an easy die, so that the helical pitch becomes less dense than the spiral portion 4e, and as a whole, it is formed as a sparse pitch portion.

Incidentally, the lighting control circuit unit 7 has a longitudinal substrate 7a, on which a lighting circuit pattern is formed, and which is fixedly fitted into a pair of longitudinal grooves formed in the inner surface of the base 2. That is, the base 2 has a pair of longitudinal grooves formed in its inner surface to extend in the axial direction of the base 2 so as to face each other along the diameter. Both widthwise edges of the longitudinal substrate 7a are fixedly fitted into the longitudinal grooves.

The longitudinal substrate 7a is formed so as to be a single-sided substrate or a double-sided substrate. A plurality of electrical components 7b, which are lighting circuit components including lead components such as electrolytic capacitors and chip components such as transistors are mounted on the mounting surface of the longitudinal substrate 7a.

One example of the specific configuration of the above configured compact fluorescent lamp 1 is as follows. That is, the maximum outer diameter of the arc tube 4 (helix outer diameter) φ2 is 54 mm, the height h1 of the arc tube 4 is 64÷1 mm, and the height h2 from the horizontal central axis of the maximum-diameter portion 4k of the arc tube 4 to the outer surface of the pair of electrode sealed end portions 4a, 4b is about 40 mm. The discharge path length between the pair of electrodes 4i, 4j is 360 to 610 mm, which varies depending on the bulb diameter of the glass bulb 4g. For example, when the diameter of the glass bulb 4g (bulb diameter) is 8 mm, the discharge path length is 476 mm. When the bulb diameter is 9 mm, the discharge path length is 374 mm. In addition, the outer diameter φ3 of the base 2 is 26 mm, and the maximum width w1 between the straight portions 4f, 4f of the arc tube 4 is approximately 1.17 times larger than the maximum outer diameter φ2 (30.5 mm) of the arc tube.

Thus, according to the compact fluorescent lamp 1 of this embodiment, the appearance approximate to the general light bulb may be obtained.

Furthermore, the spiral portion 4e of the arc tube 4 is accommodated in the spherical portion 6a having a relatively large internal volume, including the maximum-diameter portion 6c of the globe 6, so that the bulb diameter and the helix diameter both may be increased. For this reason, it is possible to increase light flux in the spiral portion 4e and also to improve luminous efficacy.

In addition, the straight portions 4f, which are the short discharge path portions of the arc tube 4 accommodated in the space adjacent to the narrow small-diameter portion 6b of the globe 6, each have a discharge path length shorter than the spiral portion 4e, so that the discharge path length required for the arc tube 4 is mostly assigned to the spiral portion 4e, thus being possible to make the bulb diameter have the same thick diameter as the spiral portion 4e. For this reason, it is possible to make the bulb diameter thick substantially over the overall length of the arc tube 4, including the straight portions 4f and spiral portion 4e of the arc tube 4.

Accordingly, the surface area per unit length of a fluorescent material film formed on the inner surface of the glass bulb 4g or the cross-sectional area of the bulb may be adjusted to an optimum value, making it possible to improve luminous efficacy.

Furthermore, since both the bulb diameter and the helix diameter are increased, it is possible to easily form the glass bulb 4g into a spiral shape through a molding process with a die and, in addition, it is possible to reduce an occurrence of cracking or distortion when the spiral portion is molded. As a result, both the mass productivity and yield percentage of the glass bulb 4g having the spiral portion 4e could be improved.

Moreover, since the bulb has a large diameter, the starting voltage and lamp voltage of the arc tube 4 may be decreased. For this reason, the output voltage of the lighting device 7 need not be increased, and the withstand voltage of components used may be lowered. Thus, it is possible to reduce manufacturing costs and, in addition, to prevent or suppress an increase in size of the lighting control circuit unit 7.

Still furthermore, the spiral portion 4e of the arc tube 4 includes the glass bulb 4g that is formed into a spiral shape, and accordingly, the light emitted inside the spiral portion 4e is likely to be blocked by the inner surface of the spiral glass bulb 4g itself. Thus, the light flux to be radiated outside of the spiral portion 4e can be reduced. However, the straight portions 4f extend in substantially parallel with the axial direction thereof in the inside of the small-diameter portion 6b of the globe 6, and accordingly, many gaps are formed and there is a little portion being blocked by the arc tube 4. Thus, the light emitted inside the spiral portion 4e and inside the straight portions 4f can increase the light flux to be radiated outside from the side adjacent to the small-diameter portion (lower side in FIG. 1) of the globe 6.

It is further to be noted that, according to the present invention, the straight portions 4f may be formed as the sparse pitch portion having a less dense spiral shape than the helical pitch of the spiral portion 4e.

That is, the sparse pitch portion may be formed so that the lower portion in FIG. 1 of the glass bulb 4g adjacent to the pair of electrode sealing end portions 4a, 4b positioned adjacent to the small-diameter portion 6b of the globe 6 is formed into a spiral shape having a smaller diameter and less dense helical pitch than the helix diameter of the spiral portion 4e, while having the same bulb diameter. Here, “the helical pitch is sparse” includes one or less turns of helix, and a half turn of helix may also be included.

For this reason, the sparse pitch portion is formed as a short discharge path portion having a discharge path length shorter than that of the spiral portion 4e by a desired length, and the spiral portion 4e is formed as a dense pitch portion having a helical pitch denser than the sparse pitch portion, while it is formed as a long discharge path portion having a long discharge path length.

Therefore, the sparse pitch portion has lower light flux and lower luminous efficacy. However, it has a sparse helical pitch, thus being possible to allow light emitted inside the spiral inner surface of the sparse pitch portion to increase the light flux to be radiated outside through a gap of the helical pitch.

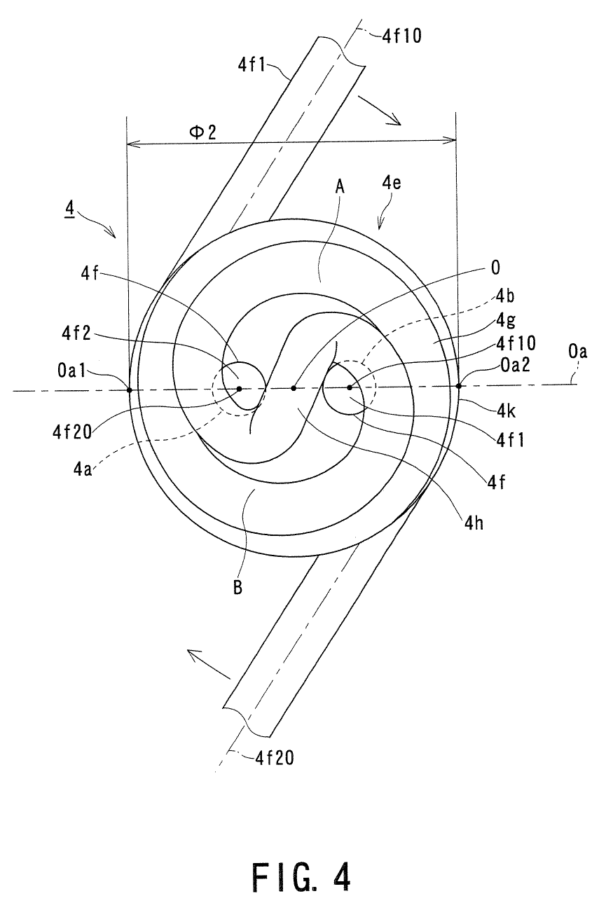

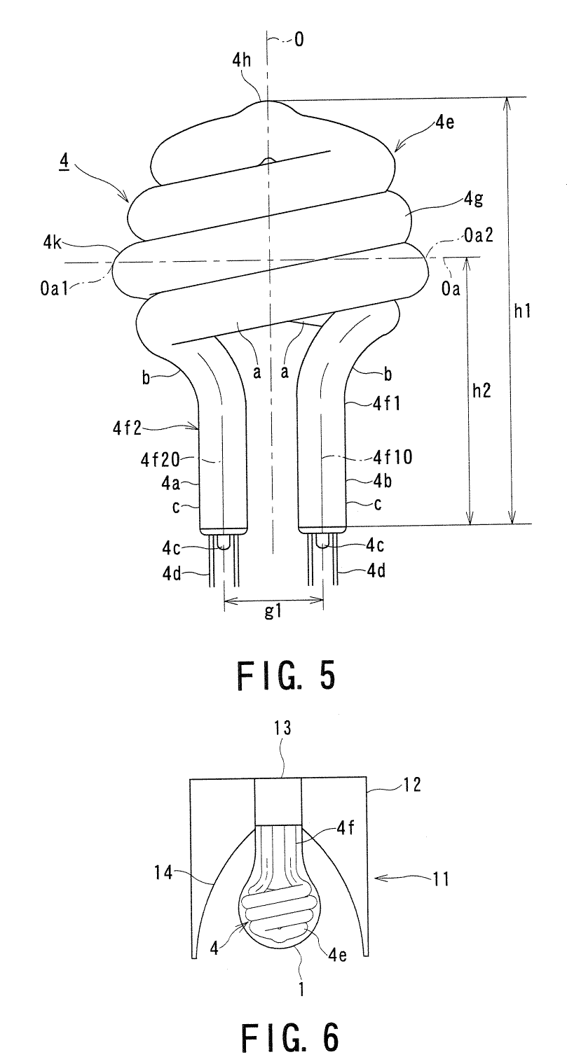

FIG. 4 is a plan view of a spiral portion 4e of the arc tube 4 showing a state that a pair of straight portions 4f, 4f are bent after the molding of the spiral portion 4e using a die, and FIG. 5 is a front view of the arc tube 4 after the straight portions 4f, 4f are bent.

That is, the arc tube 4 is formed in a manner such that the glass bulb 4g in straight circular tube shape bend into equal two portions is entirely heated and softened, which is then wound up around a die, not shown, to thereby form a double spiral-shaped spiral portion 4e.

At this time, the spiral portion 4e is formed with a vertically pair of straight tube shaped portions 4f1, 4f2 extending linearly outward in a centrifugal direction from lateral end portions Oa1, Oa2 in the diameter direction of the maximum-diameter portion 4K in FIG. 4.

Next, the straight end portions 4f1, 4f2 are bent, approximately in spiral form, around the central axis O by a spiral diameter smaller than the maximum diameter portion 6c without using any die or by using a small second die, and then directed downward on the side of the base 2 in FIG. 1 so as to mutually approach pm the central axis side. At a position in which the central axes 4f1O, 4f2O are bent each by a half peripheral portion (about 180 degrees) from both ends Oa1, Oa2 of the maximum-diameter portion 6c, the straight end portions 4f1, 4f2 are bent downward in FIG. 5, i.e., in the base side in FIG. 1, and thereby, a pair of straight portions 4f1, 4f2, i.e., a pair of electrode sealing end portions 4a, 4b are formed respectively.

Accordingly, as shown in FIG. 5, each of the paired electrode sealing end portions 4a, 4b includes, at the bulb end portion on the side lower than the maximum-diameter portion 4k of the spiral portion 4e and on an extending line of the spiral shape of the spiral portion 4e, a spiral curved portion “a” circularly curved at a desired central angle, a reduced-diameter curved portion “b” of which diameter is reduced as approaching the central axis (O) side from both the end portions of this spiral bent portion “a”, and a straight portion “c” extending linearly downward in FIG. 5 from both end portions of this reduced diameter curved portion “b”.

Therefore, these paired straight portions 4f, 4f are formed not directly straightly from both the end portions Oa1, Oa2 in the diameter direction of the maximum-diameter portion 4e, and directly formed through the spiral bent portion “a” and the reduced diameter bent portion “b” in a range of the half peripheral portion of the spiral shape (about 180 degrees), so that in comparison with the directly straightly formed case, the generation of glass strain at the time of forming the straight portions 4f, 4f into bent portions can be reduced, and the thus formed straight portion can be easily and smoothly formed, thereby improving yielding in manufacture of the arc tube 4.

Further, in this embodiment, there is provided an example in which the paired straight portions 4f, 4f are formed at the of the half peripheral portion (about 180 degrees) from both ends Oa1, Oa2 of the maximum-diameter portion 6e, but the present invention is not limited to such example, and the paired straight portions 4f, 4f may be formed by bending the bulb end portion in the range of the central angle of 270 degrees (¾ peripheral length of the spiral shape) or 90 degrees (¼ peripheral length of the spiral shape).

FIG. 6 is a schematic structural view showing a lighting apparatus 11 according to a second embodiment of the present invention. The lighting apparatus 11 is, for example, a downlight and is provided with a lighting fixture body 12. A socket 13 and a reflector 14 are mounted inside the lighting fixture body 12. The base 2 of the compact fluorescent lamp 1 is screwed into the socket 13.

According to the lighting apparatus 11 of this embodiment, since the spiral portion 4e of the compact fluorescent lamp 1, having high light flux and high luminous efficacy, faces downward in FIG. 4, so that it is possible to improve illuminance just under the compact fluorescent lamp 1.

In addition, the straight portions 4f that increase the light flux to be radiated toward the base 2 of the compact fluorescent lamp 1 is positioned adjacent to the reflector 14 of the lighting fixture body 12 to face the reflector 14, and it is therefore possible to increase the light to be reflected by the reflector 14.

It is to be noted that the present invention is not limited to the described embodiments and many other changes and modifications may be made without departing from the scopes of the appended claims.

What is claimed is:

1. A self ballasted compact fluorescent lamp comprising:
a cover including a cover body having one end to which a base is connected and another end to which a fitting end portion is formed;
a globe having a small-diameter portion formed on a side of an open end portion which is attached to the fitting end portion of the cover, small-diameter portion being smaller in diameter than a maximum-diameter portion located on a top end side of the globe opposite to the open end portion thereof;
an arc tube accommodated in the globe and provided with a bulb having a pair of electrodes, the bulb including a spiral portion connected to the electrodes, the spiral portion being located on the maximum-diameter portions side in the globe and having a helix diameter larger than the small-diameter portion of the globe at least a portion of the spiral portion, and the spiral portion further including a short discharge path portion which is continuously and integrally formed with the spiral portion, has a pair of electrode sealed end portions on the side of the small-diameter portion of the globe and has a discharge path length shorter than the spiral portion; and
a lighting control circuit unit accommodated and connected to the base in the cover.

2. The self ballasted compact fluorescent lamp according to claim 1, wherein the bulb has an outer diameter of 7 to 10 mm, and the discharge path length is 360 to 610 mm.

3. The self ballasted compact fluorescent lamp according to claim 1, wherein the maximum-diameter portion of the globe is to be 2.0 to 2.5 times an outer diameter of the base and the outer diameter of the small-diameter portion of the globe is to be 1.0 to 1.5 times of the outer diameter of the base.

4. The self ballasted compact fluorescent lamp according to claim 1, wherein a shortest distance between an inner surface of the globe and an outer surface of an arc tube is 2 to 7 mm.

5. A self ballasted compact fluorescent lamp comprising:
a cover including a cover body having one end to which a base is connected and another end to which a fitting end portion is formed;
a globe having a small-diameter portion formed on a side of an open end portion which is attached to the fitting end portion of the cover, small-diameter portion being smaller in diameter than a maximum-diameter portion located on a top end side of the globe opposite to the open end portion thereof;
an arc tube accommodated in the globe and provided with a spiral bulb having a pair of electrodes, the spiral bulb including a spiral portion connected to the electrodes, and the spiral bulb having a dense pitch portion and a sparse pitch portion, wherein the dense pitch portion is positioned on the side of the top end portion including the maximum-diameter portion of the globe and has a dense pitch of helical winding, at least partially having a helix diameter larger than the small-diameter portion of the globe, and the sparse pitch portion is continuously and integrally formed with the dense pitch portion and has a pair of electrode sealed end portions, the sparse pitch portion being positioned on the side of the small-diameter portion of the globe and has a sparse pitch of helical winding; and
a lighting control circuit unit accommodated and connected to the base in the cover.

6. The self ballasted compact fluorescent lamp according to claim 5, wherein the bulb has an outer diameter of 7 to 10 mm, and the discharge path length is 360 to 610 mm.

7. The self ballasted compact fluorescent lamp according to claim 5, wherein the maximum-diameter portion of the globe is to be 2.0 to 2.5 times an outer diameter of the base and the outer diameter of the small-diameter portion of the globe is to be 1.0 to 1.5 times of the outer diameter of the base.

8. The self ballasted compact fluorescent lamp according to claim 5, wherein a shortest distance between an inner surface of the globe and an outer surface of an arc tube is 2 to 7 mm.

9. A self ballasted compact fluorescent lamp comprising:
a cover including a cover body having one end to which a base is connected and another end to which a fitting end portion is formed;
a globe having a small-diameter portion formed on a side of an open end portion which is attached to the fitting end portion of the cover, small-diameter portion being smaller in diameter than a maximum-diameter portion located on a top end side of the globe opposite to the open end portion thereof;
an arc tube accommodated in the globe and provided with a bulb having a pair of electrodes, the bulb including a spiral portion connected to the electrodes, the spiral portion being located on the maximum-diameter portions side in the globe and having a helix diameter larger than the small-diameter portion of the globe at least a portion of the spiral portion, and the spiral portion further including a short discharge path portion which is continuously and integrally formed with the spiral portion, the bulb further including a straight portion which is continuously and integrally formed with the spiral portion and arranged on the side of the small-diameter portion of the globe, and has a pair of electrode sealed end portions extending in an axial direction of helix of the spiral portion; and
a lighting control circuit unit accommodated and connected to the base in the cover.

10. The self ballasted compact fluorescent lamp according to claim 9, wherein the bulb has an outer diameter of 7 to 10 mm, and the discharge path length is 360 to 610 mm.

11. The self ballasted compact fluorescent lamp according to claim 9, wherein the maximum-diameter portion of the globe is to be 2.0 to 2.5 times an outer diameter of the base and the outer diameter of the small-diameter portion of the globe is to be 1.0 to 1.5 times of the outer diameter of the base.

12. The self ballasted compact fluorescent lamp according to claim 9, wherein a shortest distance between an inner surface of the globe and an outer surface of an arc tube is 2 to 7 mm.

13. A self ballasted compact fluorescent lamp comprising:
a cover including a cover body having one end to which a base is connected and another end to which a fitting end portion is formed;
a globe having a small-diameter portion formed on a side of an open end portion which is attached to the fitting end portion of the cover, small-diameter portion being smaller in diameter than a maximum-diameter portion located on a top end side of the globe opposite to the open end portion thereof;
an arc tube accommodated in the globe and provided with a bulb having a pair of electrodes, the bulb including a spiral portion connected to the electrodes, the spiral portion being located on the maximum-diameter portions side in the globe and having a helix diameter larger than the small-diameter portion of the globe at least a portion of the spiral portion, and the spiral portion further including a short discharge path portion which is continuously and integrally formed with the spiral portion, the bulb further including a bulb end portion bent such that an electrode sealed end portion extends on a base side by being bent at a turning angle within ¾ peripheral length of a spiral shape on the base side from the maximum diameter portion of the spiral portion; and
a lighting control circuit unit accommodated and connected to the base in the cover.

14. The self ballasted compact fluorescent lamp according to claim 13, wherein the bulb has an outer diameter of 7 to 10 mm, and the discharge path length is 360 to 610 mm.

15. The self ballasted compact fluorescent lamp according to claim 13, wherein the maximum-diameter portion of the globe is to be 2.0 to 2.5 times an outer diameter of the base and the outer diameter of the small-diameter portion of the globe is to be 1.0 to 1.5 times of the outer diameter of the base.

16. The self ballasted compact fluorescent lamp according to claim 13, wherein a shortest distance between an inner surface of the globe and an outer surface of an arc tube is 2 to 7 mm.

17. A lighting apparatus comprising:
the self ballasted compact fluorescent lamp according to any one of claims 1, 5, 9 and 13; and
an apparatus unit body to which the compact fluorescent lamp is attached.
